(19) United States
(12) Patent Application Publication
(10) Pub. No.: US 2008/0082929 A1
(43) Pub. Date: Apr. 3, 2008

(54) Document-centric workflow systems, methods, and software based on document contents, metadata, and context

(75) Inventors: Mark D. Stignani, Minneapolis, MN (US); Stuart Dodd, Boulder, CO (US); Ron Kaminecki, Chicago, IL (US); Jerold S. Wish, Maplewood, NJ (US); Noralyn Harlow, St. Paul, MN (US)

Correspondence Address: SCHWEGMAN, LUNDBERG & WOESSNER, P.A., P.O. BOX 2938, MINNEAPOLIS, MN, 55402, US

(73) Assignee: Thomson Global Resources

(21) Appl. No.: 11/897,995

(22) Filed: Aug. 30, 2007

Related U.S. Application Data
(60) Provisional application No. 60/841,264, filed on Aug. 30, 2006.

(51) Int. Cl. G06F 3/048

(52) U.S. Cl. 715/764

(57) ABSTRACT

The present inventors devised, among other things, systems, methods, and software that allow users to readily access informational resources, such as an online legal research tools, while using document-processing applications, such as word processors. One exemplary system associates a document with a task in a workflow having multiple sequential tasks. In response to the task association, the system selects a set of computerized information-retrieval services relevant to the task and configures one or more graphical users interfaces associated with the word-processing application to facilitate access to information from the information-retrieval services and incorporation of the information in the document or in metadata associated with the document. Additionally, one or more of the graphical users interfaces allows input of and subsequent access to user notes, queries, and/or case management into the metadata.

### CROSS-REFERENCE TO RELATED APPLICATION

This application claims priority to U.S. provisional application 60/841,264, which was filed on Aug. 30, 2006 and which is incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright©2006, Thomson Global Resources.

### TECHNICAL FIELD

Various embodiments of the present invention concern information-retrieval systems, such as those that provide legal documents or other related content, and user interfaces for such systems.

### BACKGROUND

Judges and lawyers within the American legal system, as well as many others across the globe, are continually researching an ever-expanding body of legislation and judicial opinions to assist them understanding and resolving new or potential disputes. To facilitate this research, companies, such as West Publishing Company of St. Paul, Minn. (doing business as Thomson West), collect legal statutes, judicial opinions, law articles, and other legal and non-legal materials and make these available electronically over a computer network, through the Westlaw™ online research system. (Westlaw is a Trademark Licensed to Thomson West.)

At least one problem the present inventors recognized with this powerful system as well as other online research systems is that their valuable functionality is highly segregated from the functionality of other computer applications. For instance, legal researchers typically use results of their online legal research as part of a larger process of producing documents, such as legal briefs and memorandum. However, systems, such as the Westlaw system, are typically functionally separated from popular word processing applications, such as Microsoft Word or Corel WordPerfect, that are used for creating these documents. Although adds-ons such as West BriefTools™ software and West CiteLink™ software are available to identify, mark, verify, tabulate, link, and/or indicate status of legal citations in word processor documents, their functionality is isolated to legal citations. This means that for other types of legal informational needs users must leave the context of the word-processing application to execute searches via browsers or other search tools and then cut and paste information from their browsers or other search interfaces into the documents. Moreover, the inventors recognized that some valuable information found in a search but excluded from the document and may be needed later. Yet, the available tools provide nothing to address this issue.

Accordingly, the present inventors have recognized at least a need for improving functional integration of information-retrieval systems, such as Westlaw, into other applications, such as word processors.

### SUMMARY

To address this and/or other needs, the present inventors devised, among other things, systems, methods, and software that allow users to readily access informational resources, such as an online legal research tools, while using other applications, such as word processors. One exemplary computer-implemented system recognizes performance and position of a document-related task in a workflow having multiple sequential tasks. In response to the workflow position, the system selects a set of computerized information-retrieval services relevant to the task and configures one or more graphical users interfaces associated with the word-processing application to facilitate access to information from the information-retrieval services and incorporation of the information in the document or in metadata associated with the document. Additionally, one or more of the graphical users interfaces allows input of and subsequent access to user notes, queries, and/or case management into the metadata.

### BRIEF DESCRIPTION OF DRAWINGS

FIG. 1 is a block diagram of an exemplary document-processing and information-retrieval system 100, which corresponds to one or more embodiments of the present invention.

FIG. 2 is a flow chart of an exemplary method of operating system 100, which corresponds to one or more embodiments of the present invention.

FIG. 3 is a block diagram of another exemplary graphical user interface 300 which may be used within system 100 and which corresponds to one or more embodiments of the present invention.

### DESCRIPTION OF EXEMPLARY EMBODIMENT(S)

This description, which references and incorporates the above-identified Figures, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Additionally, the following copending applications are incorporated herein by reference: U.S. patent application Ser. No. 11/436,061 filed May 16, 2006; U.S. patent application Ser. No. 11/028,464 filed Jan. 3, 2005; U.S. patent application Ser. No. 10/171,170 filed Jul. 17, 2003; U.S. patent application Ser. No. 11/028,476 filed Jan. 3, 2005; U.S. patent application Ser. No. 11/343,086 filed Jan. 30, 2006.

### Exemplary Document-Processing and Information-Retrieval System

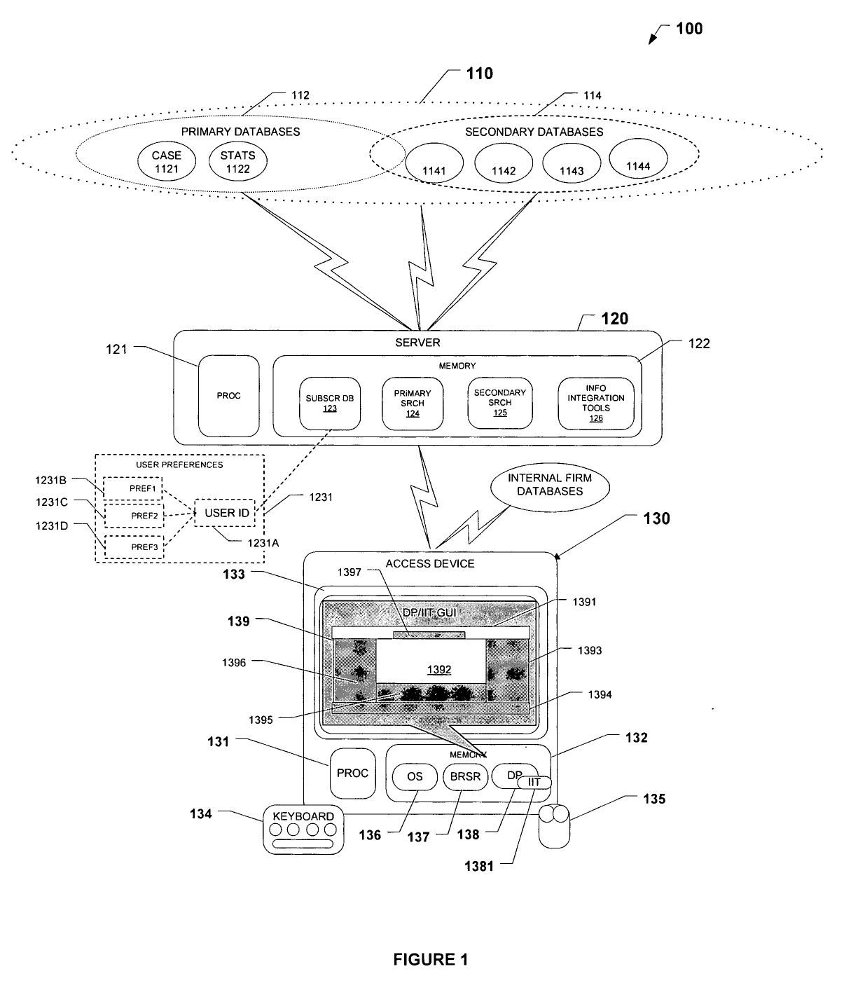

FIG. 1 shows an exemplary document-processing and information-retrieval system 100, which may be adapted to incorporate the capabilities or functions described above. System 100 includes one or more databases 110, one or more servers 120, and one or more access devices 130.

### Exemplary Databases

Databases 110 includes a set of primary databases 112 and a set of second databases 114. Primary databases 112, in the exemplary embodiment, include a caselaw database 1121 and a statutes databases 1122, which respectively include judicial opinions and statutes from one or more local, state, federal, and/or international jurisdictions. Secondary databases 114, provide attorney, judge, law firm, product, and corporate profiles. Each corporate profiles include one or more industry classification codes or indicators. In some embodiments, the caselaw documents are logically associated via a data structure with documents or profiles in databases 114. Other embodiments may include non-legal databases that include financial, scientific, or health-care information. Still other embodiments provide public or private databases, such as those made available through WESTLAW, INFOTRAC, and more generally any open web or Internet content.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

### Exemplary Server

Server 120, which is generally representative of one or more servers for serving data in the form of webpages or other markup language forms with associated applets, ActiveX controls, remote-invocation objects, or other related software and data structures to service clients of various “thicknesses.” More particularly, server 120 includes a processor module 121, a memory module 122, a subscriber database 123, a primary search module 124, a secondary search module 125, and an information-integration-tools module 126.

Processor module 121 includes one or more local or distributed processors, controllers, or virtual machines. In the exemplary embodiment, processor module 121 assumes any convenient or desirable form.

Memory module 122, which takes the exemplary form of one or more electronic, magnetic, or optical data-storage devices, stores subscriber database 123, search module 124, secondary search module 125, and information-integration-tools module 126.

Subscriber database 123 includes subscriber-related data for controlling, administering, and managing pay-as-you-go or subscription-based access of databases 110. In the exemplary embodiment, subscriber database 123 includes one or more preference data structures, of which data structure 1231 is representative. Data structure 1221 includes a customer or user identifier portion 1231A, which is logically associated with one or more operational, configuration, or usage preferences for one or more of modules 124, 125, or 126, such as preferences 1231B, 1231C, and 1231D.

Preference 1231B includes a default value governing whether document-processing tools are enabled or disabled for the associated user or customer. Preference 1231C includes a default value governing whether document metadata is stored in the subscriber database or locally with a user document. Preference 1231D includes default values governing one or more other aspects of usage or operation or configuration of the information-integration tools within module 126. For example, preference 1231D may include information defining one or more workflow sequences or templates. These sequences or templates may be defined by and/or purchased separately by the user or user's law firm or more generally employer. (In the absence of a temporary user override, for example, an override during a particular query or session, the default value governs.) In some embodiments, preference data may be stored locally on a user's access device in a local copy of one or more information-integration tools.

Primary search module 124 includes one or more search engines and related user-interface components, for receiving and processing user queries against one or more of databases 110. In the exemplary embodiment, one or more search engines associated with search module 124 provide Boolean, tf-idf, natural-language search capabilities.

Secondary module 125 includes one or more search engines for receiving and processing queries against one or more of databases 114. Some embodiments charge a separate or additional fee for searching and/or accessing documents from the secondary databases.

Information-integration-tools module 126 includes machine readable and/or executable instruction sets for wholly or partly defining software and related user interfaces having one or more portions thereof that integrate or cooperate with one or more document-processing applications. Exemplary document-processing (or document-authoring or -editing) applications include word-processing applications, email applications, presentation applications, and spreadsheet applications. (More about the module 126 is described below.) In the exemplary embodiment, these applications would be hosted on one or more accesses devices, such as access device 130.

### Exemplary Access Device

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 13 lone or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, document processing software 138. (In the exemplary embodiment, memory 132 also includes document management software and time and billing system software not shown in the FIG. 1. In some embodiments, this software may be hosted on a separate server.)

In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of graphical user interfaces on display 133. In the exemplary embodiment, document processing software 138 includes Microsoft Word word processing software, Powerpoint presentation software, Excel spreadsheet software, and Outlook email software. Document processing software is shown integrated with information-integration tools 1381, which are downloaded from server 120 via a wired or wireless communication link. Upon launching of the document processing software an integrated document-processing and information-retrieval graphical-user interface 139 is defined in memory 132 and rendered on display 133.

Upon rendering, interface 139 presents data in association with one or more interactive control features (or user-interface elements). In the exemplary embodiment, each of these control features takes the form of a hyperlink or other browser-compatible command input. User selection of some control features results in retrieval and display of at least a portion of the corresponding document within a region of interface 138 (not shown in this figure.) Although FIG. 1 shows regions as being simultaneously displayed, some embodiments present them at separate times.

More particularly, interface 139 includes document-processing tool bar region 1391, document-processing (editing and display) region 1392, and integrated information regions 1393-1397. In the exemplary embodiment, region 1393 includes control and display elements for external content and services, such as provided by server 120 and databases 110. Region 1394 includes control and display elements for metadata content related to completing a task related to authoring a document loaded into document-processing window 1392. For example, region 1394 may list contact data regarding all persons, such as law-firm and client personnel, opposing legal counsel and court personnel, and witnesses associated with a legal case for which the loaded document is being prepared. Region 1395 includes control and display elements for internal content, from internal law firm databases, for example electronic discovery databases, litigation strategy documents, related legal documents and memorandum from other cases, and so forth. Region 1396 includes specific workflow information and control elements related to the user who launched the document-processing application and/or generic workflow information accessible via the user. In some embodiment, the user may select a workflow step or task within region 1396 and initiate update of the content or available tools and services shown in one or more of the other information regions.

Also, in the exemplary embodiment, the information integration tools are extensible to include local desktop tools, such as BriefTools, CiteLink, DealProof, LiveNote, local server tools and services, such as West km knowledge management system, ES, and Elite accounting, and remote tools and services, such as KeyCite and other Thomson or third party tools and services.

### Exemplary Method(s) of Operation

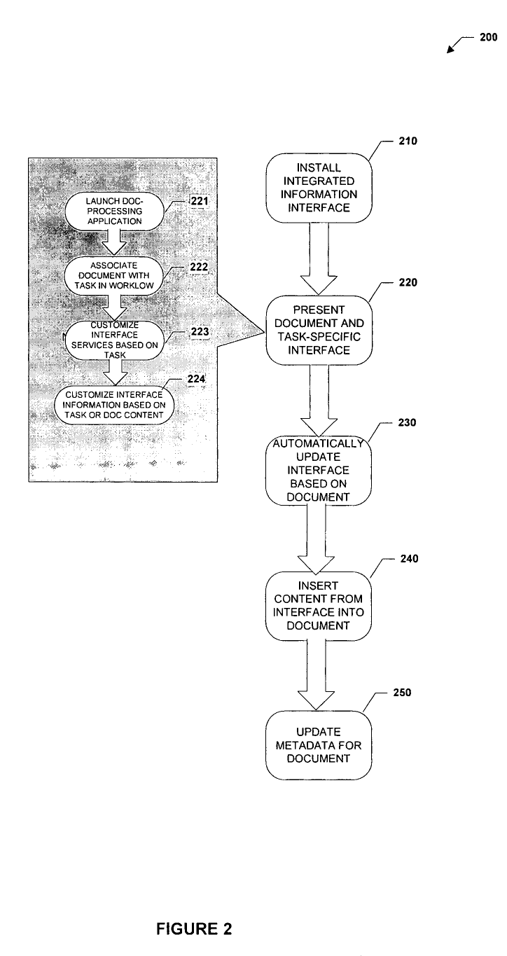

FIG. 2 shows a flow chart 200 of one or more exemplary methods of operating a system, such as system 100. Flow chart 200 includes blocks 210-250, which are arranged and described in a serial execution sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow applies to software, hardware, and firmware implementations.

Block 210 entails installing the client version of information integration software stored on server 120 onto one or more client devices. In the exemplary embodiment, this entails a user directing a browser in a client access device, such as access device 130, to internet-protocol (IP) address for an online information-retrieval system, such as the Westlaw system and then logging onto the system using a username and/or password. Successful login results in a web-based interface being output from server 120, stored in memory 132, and displayed by client access device 130.

The interface includes an option for initiating download of information integration software with corresponding toolbar plug-ins for one or more applications. If the download option is initiated, download administration software ensures that the client access device is compatible with the information integration software and detects which document-processing applications on the access device are compatible with the information integration software. With user approval, the appropriate software is downloaded and installed on the client device. Execution continues at block 220.

Block 220 entails presenting a task specific document and integrated information interface. In the exemplary embodiment this entails execution of process blocks 221-225.

Block 221 entails launching of one or more document-processing applications having information integration tools. In the exemplary embodiment, this entails a user launching and opening or creating a document using one or more of the following independent applications: Microsoft Word word processing application, Corel WordPerfect word processing application, Internet Explorer browser application, Adobe Acrobat desktop publishing application, and Microsoft Outlook email application. Execution continues at block 222.

Block 222 entails associating the document with a task and in a workflow sequence. In some embodiments, task recognition is based on the identity of the user who launched the document-processing application. For example, the user may be a legal secretary, a paralegal, a senior-level lawyer, junior-level lawyer, expert witness, or a client associated with an legal case. In some embodiments, user identify is detected based on the name associated with the access device hosting the document-processing application or associated with the document. In some embodiments, the user may select a task from a workflow menu listing a set of two or more sequential tasks and in others the workflow position of a document is determined based on user identify in combination with the current date, docketing dates, title, and/or audit trail of the document within a document management system.

Block 223 entails automatically identifying a set of information services relevant to the task from a universe of available information services and defining or populating the information integration interface based on the identified information services. The exemplary embodiment, provides three types of in-context services via the interface: litigation services, transactional services, general enterprise services, and system services. Exemplary litigation services include citation identification, extraction, validation, markup, linking, advise, and classification. Exemplary transactional (law) services include entity extraction, tagging, and document deconstruction (Deal Proof software tool). Exemplary enterprise services include full-text search, citation search, citing reference search, document production, clause library search. Additionally, one or more of these services are associated with specific tasks in one or more defined workflows, enabling the control features for the service to presented when the specific task is detected. Execution continues at block 224.

Block 224 entails automatically presenting related information in the integrated information interface based on the current task or previously completed tasks (or steps) in the workflow. In the exemplary embodiment, this entails the system automatically scanning text within the active window for predetermined textual or grammatical forms, such as entity names (attorneys, companies, judges, witnesses, places, etc.). For example, some embodiments use the metadata associated with the document, such as that included within region 1396 as a starting point for determining what to look for in a document. However, other embodiments may present relevant information in some portions of the interface based on the metadata content alone or in combination with actual document content. Additionally, some embodiments may automatically identity predetermined concepts based on the content of the document.

In the exemplary embodiment, the query process entails the one or more portion of the information integration software to communicate with server 120 directly or to use a local browser capability to submit queries of local and/or remote databases. In some embodiments, the queries are embedded as parameters within one or more Uniform Resource Locators (URLs). In some embodiments, the URL, includes an embedded password to enable transparent authentication of the user at the server; also, an embedded client identifier or docket number facilitates cost recovery for the data retrieval by associating the search activity with the client identifier. Execution proceeds to block 230.

Block 230 entails automatically updating the integrated information interface during processing of a document. In the exemplary embodiment, this entails the system automatically monitoring changes to the document within the active window for predetermined textual or grammatical forms, concepts, and so forth (as noted above for block 224, dynamically initiating queries for related data from internal and external databases, and populating corresponding portions of the integrated information interface with any resulting data.

Block 240 entails inserting one or more portion of the displayed information into the document or into a notes area of the information interface. In the exemplary embodiment, this entails the user selecting a document from a listing of documents returned by the server, using a pointing device. Once selected, the user may invoke an interactive command icon on an interface portion of the research application and cause insertion of document or one or more selected portions of the document into the active window.

In response, the selected portion(s) of the documents will be inserted at the current cursor position of the document in the active window. In some embodiments, the selected text inserted into the document along with associated bibliographic data, such as citation with appropriate citation data according to a “blue book” or scientific format. In some instances, this data is merely associated as meta data with the inserted text. In other embodiments, this citation insertion behavior is governed by one or more user preferences in a configuration file maintained for the user on server 120.

Block 250 entails updating the metadata associated with the document to reflect activity during an editing session. In the exemplary embodiment, this entails updating the metadata for the document to reflect the results of any past actions made through the interface, identity and links to related documents consulted or from which content was cut and paste into the document, resolved entities detected or added to the document, resolved assets, resolved events, resolved subjects. Additionally, the metadata is updated to reflect any notes or queries manually defined by a user. Time and billing information may also be added to facilitate capture of billable time. Also in the exemplary embodiment, the metadata is part of the document file. Thus, if the document is carried forward to another task-aware workflow application, the application can autoload entity data, dates, link past documents/related documents into the integrated information interface. In some embodiments, the metadata managed by the integrated information interface is encrypted so that it can be accessed only using appropriate credentials in combination with a properly licensed integrated information interface.

### Exemplary Integrated Document Processing and Information Retrieval Interface

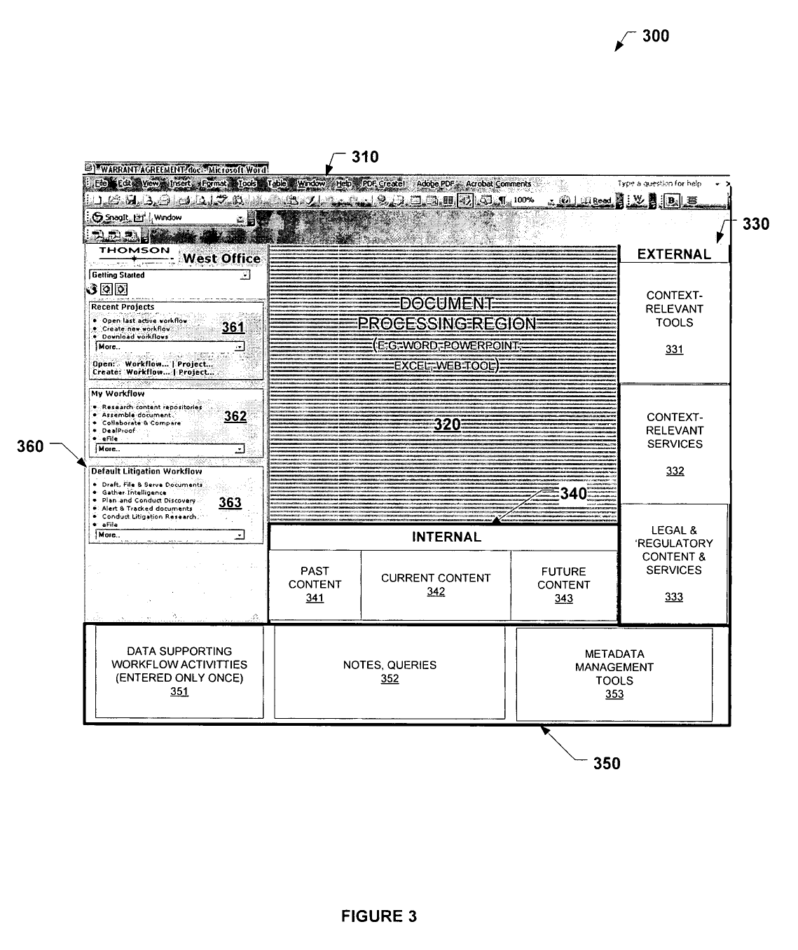

FIG. 3 shows an exemplary graphical user interface 300 which may be substituted for the interface 139 in FIG. 1. Interface 300 includes a document processing tool bar region 310, a document processing region (or active edit window) 320, an external information region 330, an internal information region 340, a metadata region 350, and an workflow region 360.

Document processing tool bar region 310 and document processing region 320 are native to a document processing application, such as Microsoft Word. Remaining regions 330-360, in the exemplary embodiment, are provided as add-ons as described above.

External information region 330 includes context relevant tools region 331, context relevant services 332, and legal & regulatory content & services region 333. In the exemplary embodiment, each of these regions provides one or more control elements, such as menus and links and display regions for accessing and/or commanding tools, services, or content from external sources, such as from databases 110 or via server 120 (in FIG. 1.).

Internal information region 340 includes past content region 341, current (or present) content region 342, and future content region 343. The past content region displays multiple categories of relevant documents based on past tasks within a workflow associated with the document. Current content region 342 displays multiple categories of relevant internal documents based on the current task or work being performed on the document. Future content region 343 displays recommended calendar events that are related to the document or workflow task. In the exemplary embodiment, each of regions within 340 provide one or more control elements (widgets) for accessing and/or commanding tools, services, or content from internal sources, such as the access device itself, from internal lawfirm knowledge management systems, document management systems, time and billing systems, accounting system, litigation databases, etc.

Metadata region 350 includes supporting data region 351, notes region 352, and metadata management tools region 353. In the exemplary embodiment, these regions provide one or more control elements for accessing, viewing, entering, editing, outputting, encrypting metadata associated with a document within the document processing region.

Workflow region 361 includes a recent projects region 361, a my workflow region 362, and a default litigation workflow region 363. In the exemplary embodiment, each of the regions within region 261 include one or more control elements for accessing, viewing, defining, editing, selecting workflows, that is, sequential listings of tasks. Additionally, tasks in workflows associated with documents can be annotated to indicate status, completion dates, participants, quality control reviews, and so forth.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. A computer-implemented system comprising:
means for associating a document in a document-processing application with a task in a workflow having a plurality of sequential tasks, including at least one of a prior task and a succeeding task;
means, responsive to the associated task, for defining a graphical user interface associated with the document-processing application to include control elements for one or more computerized services relevant to the task; and
means for linking information from external or internal databases to the graphical user interface for facilitating selective access and/or incorporation of the linked information into the document.

2. The system of claim 1, wherein the system comprises a server and a client access device communicatively coupled to the server via a network, with each of the client access device and the server including one or more of the means recited above.

3. The system of claim 2, wherein the external databases are part of an online legal research service.

4. A computer-implemented method comprising:
associating a document in a document-processing application with a task in a workflow having a plurality of sequential tasks, including at least one of a prior task and a succeeding task;
in response to the task being associated with the document, defining a graphical user interface associated with the document-processing application to include control elements for one or more computerized services relevant to the task; and
linking information from external or internal databases with the graphical user interface for facilitating selective access and/or incorporation of the linked information into the document.

5. The method of claim 4, wherein associating the document with the task comprises receiving a user selection of the task from a list of two or more tasks in a menu associated with the workflow.

6. The method of claim 4, wherein the external databases are part of a subscription-funded online legal research service.
